(19) United States
(12) Patent Application Publication
(10) Pub. No.: US 2010/0235972 A1
(43) Pub. Date: Sep. 23, 2010

(54) FUEL REPELLENT COMPOSITIONS, FABRICS AND ARTICLES

(76) Inventor: Michael N. Guasch, Walnut Creek, CA (US)

Correspondence Address: Zilka-Kotab, PC, P.O. BOX 721120, SAN JOSE, CA, 95172-1120, US

(21) Appl. No.: 11/460,175

(22) Filed: Jul. 26, 2006

Related U.S. Application Data
(60) Provisional application No. 60/704,094, filed on Jul. 28, 2005.

(51) Int. Cl. A62B 17/00; B05D 3/02

(52) U.S. Cl. 2/458; 427/389.9; 427/387; 427/393

(57) ABSTRACT

Compositions including a fluorocompound and optional adjuncts afford fire and flame safety by resisting, mitigating or preventing sorption of inflammable liquids such as fuels, Methods of use are presented, and generally include application of a composition to a substrate. Treated substrates arc presented, and include fibers, fabrics, and articles such as garments.

### RELATED APPLICATIONS

This application claims priority to the U.S. Provisional Patent Application Ser. No. 60/704,094 filed Jul. 28, 2005,

### BACKGROUND OF THE INVENTION

1. Field of the Invention

The present invention relates generally to fire protective compositions and fire protective materials and articles, and in particular to fire protective compositions, fibers, materials and garments which enhance fire protection by resisting sorption of combustible liquids, especially fuels.

2. Description of Related Art

Fire and flame resistant or retardant fabrics are well known in the art, and have numerous applications including protective garments, upholstery and lining materials for vehicles and aircraft, linings and shielding for electrical equipment, telecommunications, computer, utilities, petroleum and chemical industries, cable and conduit wraps, optical fiber coatings, grease filled wire and cable, communications towers, fire penetration barriers, seals, pipeline wraps, storage tanks, reactors, ovens, distillation columns, furnaces and household uses. Fire lighters and those exposed to hazardous or potentially hazardous conditions have benefited from fabrics which are resistant to fire, such, as Dupont's NOMEX® brand of aromatic polyamide fibers. Also known to the art are fabric coatings which impart to the fabric water and stain repellence. Such coatings include fluoro-compounds and/or fluoropolymers, such as Teflon® and SCOTCHGARD® stain protectors.

Intumescent materials are similarly well known. Such materials endeavor to provide a thermal and physical barrier to slow transport of heat and flame spread of fires. These materials generally act to provide an insulating layer between the flame front and the substrate protected by the intumescent material. Substrates susceptible of protection by such intumescent materials are generally limited to construction materials, such as wood, steel, aluminum and the like, U.S. Pat. No. 5,723,515 to Gottfried describes Intumescent compositions which are comprised of a multitude of materials.

U.S. Patent Application Publication number 2004/0002559 to Trontman et al. discloses a flame retardant coating comprising a sterically hindered nitroxyl, hydroxylamine or alkoxyamine stabilizer, combined with organohalogen, organophosphorous, isocyanurate or melamine flame retardant.

Numerous references disclose the use of various materials to coat fabrics to impart to the fabric fire resistant properties, or to improve fire resistance.

U.S. Pat. No. 5,393,812 to Haley et al. discloses polyolefin compositions which are made flame retardant by a combination of a halogenated hydrocarbyl phosphate or phosphonate ester flame retardant in combination with an alkoxyamine functional hindered amine. U.S. Pat. No. 6,117,995 to Zedda et al. discloses certain N-alkoxy hindered amines as flame retardants for organic polymers.

U.S. Pat. No. 4,232,087 to Trask describes a method for coating fibers, which may comprise a polyaramid, with a polytetrafluoroethylene chromium complex. The requirement for a chromium complex may render the method environmentally unsound and impractical, and the disclosure appears to be limited to improving oil repellency of fibers having utility as filter fabrics. Trask describes a method for depositing a polytetrafluoroethylene (PTFE) as a plurality of fine particles.

Other patents disclose various coating materials and treatment methods to impart soil and stain repellency to a variety of fabrics. Specifically, U.S. Pat. NO. 5,565,265, to Rubin et al discloses polyester fabric treated with a fluoropolymer to improve liquid and stain resistance.

U.S. Pat. No. 5,284,902 to Huber et al. to discloses a fluorochemical composition exhibiting water and oil repellency properties.

The art has thus far been limited to various fiber constructs, articles, garments, coatings and combinations thereof, which are themselves resistant to combustion, and/or which act as a barrier to heat transmission or flame spread. However, such fibers are susceptible to absorption of inflammable materials, for example, fuels such as gasoline. A fire protective garment which, becomes soaked with an inflammable liquid is wholly insufficient in offering fire protection. Fire protective garments are commonly used under circumstances wherein quantities of inflammable fuels are present, for example in motor sports. Such protective garments also have applications in aviation, especially, military and flight test, automobile racing, boat racing, and any potentially hazardous endeavor involving inflammable fuels. Periodically, accidents occur wherein fuel is spilled onto persons wearing garments purporting to provide protection, which fuel then combusts, or fuel is spilled in an already burning state onto persons wearing such garments. Paradoxically, while the use of polyaramid protective garments is common in these situations, the art has not taught, disclosed or suggested a composition, article or method for mitigating the hazards of fuel soaking into the garment, then igniting (or already burning fuel soaking into the garment). The art is thus deficient in teaching, suggesting or disclosing a method, composition, fabric, garment and/or article which exhibits improved safety against combustion by virtue of an ability to both resist inflammation, and to farther mitigate or prevent the sorption by the fabric or garment of an inflammable material, especially a fuel such as gasoline.

### SUMMARY OF THE INVENTION

The compositions, methods, fibers (including a woven mesh of fibers), fabrics and articles of the present invention afford fire and flame safety by resisting, mitigating or preventing sorption of inflammable liquids, especially fuels, and in particular, hydrocarbon fuels such as alcohols, methanol, ethanol, gasoline, kerosene, diesel fuel and jet fuel. Such inflammable liquids include, but are not limited to, aliphatic and aromatic alkanes, alkenes and alkynes, such as, for example, nitromethane, methane, pentane, hexane, heptane, octane, hydrocarbons, lower alcohols, diols, fuels used in motor sports, and mixtures thereof. Suitable substrates for the protective composition include, but are not limited to fibers, fabrics and garments of polyaramid (such, as Nomex®), meta-aramid, polyacrylonitrile and oxidized polyacrylonitrile, such as CarbonX®, leather, polyesters, cotton, nylon, wood, and combinations thereof.

In one embodiment of the present invention, the fiber or fabric comprises a polyaramid or a polyacrylonitrile, and the flammable liquid preferably prevented from sorbing thereon comprises a fuel such as gasoline, or any motorsport fuel.

The compositions of the present invention comprise a fluorocompound. In one embodiment of the present invention, the fluorocompound is of the type comprising an oligomeric or polymeric backbone with at least one pendant fluorine-containing group. In another embodiment of the present invention, the fluorocompound comprises an oligomer or polymer containing fluorine. In another embodiment of the present invention, the fluorocompound comprises a fluorosurfactant. In another embodiment of the present invention, the fluorocompound comprises a fluorinated polyurethane which can be cross-linked or not.

In one embodiment of the present invention, a composition comprises a fluorocompound and water. In another embodiment a composition of the present invention comprises a fluorocompound, a crosslinking agent, and water. In another embodiment, a composition of the present invention comprises a fluorocompound, a crosslinking agent, and water, and optionally a wax, and a copolymer. In still another embodiment, a composition of the present invention comprises a fluorocompound, and a solvent.

In one embodiment, a composition of the present invention comprises a coating for depositing onto a fiber, fabric or article which coating decreases the effective surface energy of the treated fiber, fabric or article such that absorption of a liquid from which protection desired is mitigated/retarded, including liquids having low surface tension. Thus, the composition, prevents or mitigates sorption, by the fiber, fabric or article of flammable materials, especially fuels.

In one embodiment, the present invention comprises a fiber or protective garment having a composition deposited thereon, which composition decreases the effective surface energy at the interface to prevent or mitigate sorption by the garment of flammable materials, especially fuels. In a preferred embodiment, sorption of fuel is reduced by at least 20%, and more preferably by at least 30%, for at least 30 seconds, compared to said fiber or garment without the fluorocompound present.

In another embodiment, the present invention comprises a fiber or protective garment having a composition deposited thereon, which composition decreases the effective surface energy of the treated item to prevent or mitigate sorption by the garment of flammable materials, especially gasoline and/or motorsport fuels.

In another embodiment, the present invention comprises a polyaramid fiber, which may be derived from meta-aramids, such as meta phenyleneisophthalamide having a coating deposited thereon which decreases the effective surface energy of the treated item, the coating comprising at least one fluorocompound, and optionally, a cross-linking agent.

In another embodiment, the present invention comprises a polyacrylonitrile or oxidized polyacrylonitrile fiber having a coating deposited thereon which decreases the effective surface energy of the treated item, the coating comprising at least one fluorocompound, and optionally, a cross-linking agent such as a silicone-containing material.

In yet another embodiment the present invention comprises a garment or wearing apparel comprised of polyaramid fibers, which may be derived from meta-aramids, such as meta phenyleneisophthalamide, or a garment or apparel comprised of polyacrylonitrile, having a composition deposited thereon which decreases the effective surface energy of the treated item at the interface of the composition and the liquid from which protection is desired, to prevent or mitigate sorption by the garment or apparel of flammable liquids, especially gasoline and fuels used in motor sports, the composition comprising at least one fluorocompound.

A method of the present invention comprises applying the composition onto the fiber or fabric substrate and curing. The composition may be applied to the substrate by spraying, rolling, padding, dipping, brushing, or any other method of application. In one embodiment of the present invention, the curing comprises drying, e.g., at a temperature of about 15° C. or more. The fabric substrate may be allowed to air dry, or force dried, in an apparatus such as a dryer or using an apparatus such as an air blower or contact heater.

Another embodiment of the present invention comprises applying the composition onto the fabric substrate, the composition in one embodiment including a curing agent, and allowing the composition to cure onto the fabric substrate.

### DETAILED DESCRIPTION OF THE INVENTION

The following description is the best mode presently contemplated for carrying out the present invention. This description is made for the purpose of illustrating the general principles of the present invention and is not meant to limit the inventive concepts claimed herein. Further, particular features described herein can be used in combination with other described features in each of the various possible combinations and permutations.

### DEFINITIONS

“Fuel” means a liquid or gas comprising a hydrocarbon, material which is intended for combustion.

“Hydrocarbon” means a compound comprising hydrogen and carbon, but may include other elements as well. Hydrocarbons include, but are not limited to, lower alkanes such as alcohols, and may be aliphatic or aromatic. Hydrocarbons may be derived from petroleum or not.

“Gasoline” means a petroleum-derived liquid mixture consisting primarily of C₅₋₁₂ hydrocarbons, intended for use as fuel in internal combustion engines.

“Sorption” is defined to include both absorption and adsorption, unless otherwise clear from the context. Absorption is defined as the incorporation of a substance in one state into another of a different state (e.g., liquids being absorbed by a solid, or gases being absorbed by water). Adsorption is the physical adherence or bonding of ions and molecules onto the surface of another molecule or molecules.

The compositions, methods, fibers, fabrics and articles of the present invention afford fire and flame safety by resisting, mitigating or preventing sorption of inflammable liquids such as fuels, e.g., hydrocarbon fuels such as methanol, ethanol, alcohols, gasoline, kerosene, diesel fuel, jet fuel, fuels used in motor sports, and mixtures thereof. Illustrative inflammable liquids include, but are not limited to, aliphatic and aromatic alkanes, alkenes and alkynes, such as, for example, nitromethane, pentane, hexane, heptane, octane, hydrocarbons, lower alcohols, diols, and mixtures thereof.

The compositions of the present invention comprise a fluorocompound. In one embodiment of the present invention, a composition comprises a fluorocompound and water. In another embodiment a composition of the present invention comprises a fluorocompound, a crosslinking agent, and water. In another embodiment, a composition of the present invention, comprises a fluorocompound, a crosslinking agent, and water, and optionally includes a wax, and a copolymer. In still another embodiment, a composition of the present invention comprises a fluorocompound, and a solvent.

Suitable substrates for the protective composition include, but are not limited to, fibers (e.g., strands, threads, etc.), fabrics (e.g., woven mesh of fibers), and/or sheets of polyaramid, such as Kevlar® and Nomex®; oxidized polyacrylonitrile (including thermal-stabilized forms), such as CarbonX®, and Panox®; leather, polyesters; cotton; nylon; paper; and combinations thereof. The fabrics may further comprise garments, wearing apparel, upholstery, protective sheathing, protective wrapping, protective draping, protective coverings such as a sheet or blanket, and the like. In one embodiment of the present invention, the fabric comprises a polyaramid, and the flammable liquid preferably prevented from sorbing thereon comprises gasoline.

Suitable substrates further include fibers, fabrics, and garments which include a pre-existing flame or fire retardant coating such as Proban®.

Additional suitable substrates include other articles of manufacture such as paper, cardboard and other wood products, etc.

Each of the components will be further described below.

Fluorocompound (also may be known as a fluorochemical). In one embodiment of the present invention, the fluorocompound is of the type comprising an oligomeric or polymeric backbone with at least one pendant fluorine-containing group. The oligomeric or polymeric backbone may comprise acrylate, methacrylate, methylmethacrylate, or combinations thereof, and may be a homopolymer or copolymer. In one embodiment, the fluorocompound is a fluoropolymer marketed by Innovative Chemical Technologies, Inc. of Cartersville, Ga., and sold under the trademark Flexipel™. A preferred Flexipel is Flexipel FC 2710C. Another suitable fluorocompound is manufactured by the Dupont Company under the trademark Zonyl®. Also preferred are Fluorolink® fluorocompounds, marketed by Solvay Solexis of Thorofare, N.J. The Fluorolink series includes fluorinated polyurethanes sold under the names: Fluorolink P56, Fluorolink 5049 and Fluorolink 5083X. These Fluorolinks may be crosslinked or not. Yet another suitable fluorocompound is manufactured by the Dupont Company under the trademark Krytox®. DuPont's Krytox® line is water insoluble, while other fluorocompounds are water soluble. Accordingly, the composition can include an aqueous or a non-aqueous base. While an aqueous base is preferred for ease of use and environmental reasons, non-aqueous executions are also within the scope of the disclosure.

Crosslinking agent. This is an optional component to the inventive compositions, and articles containing or coated therewith. When included, the cross-linking agent can function to improve the surface integrity of the fluorocompound on the surface of the substrate, and/or to itself or both. The crosslinking agent thus acts to cure the fluorocompound to itself and/or the substrate, or to both itself and to the substrate, resulting in a consistent and contiguous film of fluorocompound. In one embodiment of the present invention, a crosslinking agent comprises a silicone, for example silanes, siloxanes, and mixtures thereof.

Optional Ingredients. The inventive compositions comprising the fluorocompound and water, and articles containing or coated therewith may further include waxes, such as paraffins, polymers and copolymers such as polymers comprising acrylic acid/acrylate. Surfactants, comprising nonionic, anionic, cationic, zwitterionic, amphoteric and mixtures thereof may be included. As noted above, in some embodiments of the present invention, the compositions may be non-aqueous, in which case solvents, such as acetone may be present. A pH modifier may be added to alter pH either up or down as conditions dictate.

It may also be advantageous to include in a composition of the present invention a zeta potential modifier to adjust the zeta potential of the treatment solution to a positive value greater than zero. Examples of zeta potential modifiers including cationic agents including, for example, cationic monomers, polymers, and copolymers comprising cationic monomers, wherein the cationic monomer is present at least to an extent sufficient to provide an overall net cationic nature, i.e. overall positive charge, to the copolymer. Preferred cationic agents include cationic surfactants.

In one embodiment a composition of the present invention comprises a composition for depositing or applying as a coating onto a fiber, fabric, article or garment, which composition decreases the effective surface energy of the treated item to prevent or mitigate sorption by the fiber, fabric, article or garment of flammable materials, especially fuels such as gasoline which typically have low surface tension. The deposition onto the fiber (or other substrate) of the compositions of the present invention results in a fiber (or substrate) with a sufficiently low surface energy such that the fiber (or substrate) repels, or resists sorption of, flammable liquids, in particular fuels, especially gasoline. The compositions of the present invention thus impart a low energy to the surface which means even a low surface-tension liquid, such as a fuel like gasoline, are less prone to penetrate the surface.

In one embodiment, the present invention comprises a fiber, fabric or garment having a composition deposited thereon, which composition decreases the effective surface energy of the treated item to prevent or mitigate sorption by the fiber, fabric or garment of flammable materials, especially fuels such as gasoline and motorsport fuels.

In another embodiment, the present invention comprises a polyaramid fiber, which may be derived from meta-aramids, such as meta phenyleneisophthalamide, or a polyacrylonitrile or oxidized polyacrylonitrile, the fiber having a composition deposited thereon which decreases the effective surface energy of the treated item, the composition comprising at least one fluorocompound, and optionally, a cross-linking agent.

In yet another embodiment the present invention comprises a garment or wearing apparel comprised of polyaramid fibers, which may be derived from meta-aramids, such as meta phenyleneisophthalamide, or a polyacrylonitrile or oxidized polyacrylonitrile, the garment or apparel having a composition deposited thereon which decreases the effective surface energy of the treated item to prevent or mitigate sorption by the garment or apparel of flammable materials, especially gasoline and motorsport fuels, the composition comprising at least one fluorocompound, and optionally, a cross-linking agent.

In preferred embodiments, the effective amount of fluorocompound active in the compositions described herein is between about 0.1 wt % and about 100 wt % of the composition as applied to the substrate. Of course the amount of active in the composition can be lower than the range stated here. The remaining ingredients in the composition may include one or more of a carrier such as water, a solvent or both; adjuncts such as the crosslinking agents, curing agents, and optional ingredients disclosed herein; as well as other adjuncts.

Example Composition 1: 25% Flexipel FC 2710-C, plus 75% water.

Example Composition 2: 25% Fluorolink P56 plus 75% water

Example Composition 3: 20% Fluorolink 5083X (fluoropolyurethane with crosslinkable siloxane groups), plus 80% water

Example Composition 4: 25% Flexipel FC 2710-C, 0.5-2% acetic acid pH adjuster, plus remainder, water.

A method of the present invention comprises applying the composition onto the substrate and curing by drying. The step of applying can comprise immersing the substrate, e.g., fiber, fabric, sheet or article, in an aqueous solution containing a composition of the present invention, or can comprise spraying, or any other method known to the art to imbue a liquid onto a substrate.

A method according to one embodiment of the present invention further comprises applying the composition onto the substrate, the composition including a curing agent, and allowing the composition to cure onto the fabric. When a curing agent is included, a separate drying step is not required, although such a step may be employed.

The composition may be applied to the substrate by spraying, rolling, padding, dipping (including immersion), brushing, or any other method of application. While a light coating of the composition will provide some protective properties, a preferred method applies enough spray to saturate the substrate. The methods of applying the composition by spraying are diverse. Some examples include application by hand using a spray bottle, application by fixed or automated sprayer such as would be used for spraying fabric as it comes off of or is wrapped onto a roll, etc.

If the composition is applied by immersion, the immersion may occur, for example, in a conventional washing machine. The drying step allows the composition to cure onto the substrate as a continuous and contiguous thin film, thus affording optimal protection against fuel sorption, and concomitant fire protection. In general, the drying step may be performed until the carrier in the applied composition is substantially absent from the substrate. The substrate may be allowed to dry under ambient, i.e. normal room conditions, or dried in a drier. If dried under ambient conditions, it is preferable that a drying period of 1 to 12 hours is provided. If a dryer is used, it is preferred that a temperature range of 15° C. to 200° C., and more preferably 50° C. to 100° C., is used, for a time period of about 5 to 180 minutes. Other or additional modes of drying are also contemplated. For example, air flow (heated or unhealed) and/or agitation such as tumbling may be used to facilitate the drying. A contact heater such as an iron may also be used.

In one embodiment of the present invention, a fabric, for example a garment, is treated with a composition of the present invention by laundering, that is by fully or partially immersing the fabric in an aqueous liquor containing at least one detergent or surfactant, and a protective composition of the present invention. The immersion may occur, for example, in a conventional washing machine. The composition of the present invention advantageously may be added to the wash liquor before or after a detergent or other surfactant, or concurrently therewith. Such use of detergent or other surfactant and/or agitation in a washing machine does not adversely affect the protective qualities of the compositions of the present invention. It is, however, preferred, that when laundering garments or articles treated with a composition of the present invention, that the garment or article is first washed with detergent, then rinsed. The composition of the present invention is then added in a subsequent wash or rinse cycle after the fabric has been rinsed and detergent has been removed. Following laundering, the fabric or garment is dried by air drying at ambient to elevated temperatures, preferably at temperatures from 15° C. to 80° C. Such drying may occur in a dryer, and/or may be accompanied by tumbling, agitation or air flow, or may occur in a static manner.

In a further embodiment, the composition can be applied to the substrate via a roller that carries the composition into contact with the substrate. This embodiment is least likely to waste the composition, as any composition not applied to the substrate should adhere to the roller and can be applied to the next section of substrate.

When applied to the substrate, especially a garment, the compositions of the present invention preferably impart to the substrate a lower surface energy whereby liquid hydrocarbons, especially inflammable liquid hydrocarbons will not absorb into, nor adsorb onto, the treated fiber or fabric. The surface energy is decreased to below about 25 dyne/cm, preferably below about 20 dyne/cm, and more preferably below about 18 dyne/cm.

The compositions of the present invention, when applied as described herein and cured to the fabric, article or garment, further do not impart a noticeably unusual feel to the fabric, article or garment, thus making the fabric, article or garment particularly suitable for protective garments. Fabrics, articles or garments of the present invention thus maintain a desirable “hand” or texture.

### Experimental

American Association of Textile Chemists and Colorists (AATCC)-118-2002 Hydrocarbon Resistance Test

A composition of the present invention, as prepared in Example 1, after being applied by immersing a Nomex® fire retardant fabric for 20 seconds, followed by curing at about 80° C. for 2 minutes, passes the AATCC-1.18-2002 Hydrocarbon Resistance Test with at least a number 7 test liquid for 30 seconds, and preferably passes a number 8 test liquid for 30 seconds, and more preferably passes a gasoline test liquid for 30 seconds, and most preferably passes a gasoline test liquid for 60 seconds. In the test described above, a number 7 test liquid generally comprises octane, while a number 8 test liquid generally comprises heptane.

The AATCC test measures a material's resistance to wetting by a series of liquids having different surface tensions. The test is conducted by applying drops of the liquid to uniformly-sized swatches of test fabric, and visually observing and grading the results.

Water Repellency Spray Test—AATCC

Gasoline repellency was measured by the standard AATCC Water Repellency test method. Samples were rated for gasoline repellency as determined by a pattern of surface wetting. Eight inch square samples were prepared, and held taut at a 45 degree angle. About 250 ml of gasoline at a room temperature were dropped onto the sample from a distance of about 10 cm above the center of the sample. After all of the gasoline has fallen, the sample is tapped lightly to remove excess, and rated according to a numerical scale.

A composition of the present invention, as prepared using the composition of Example 1, after being applied as described above and cured to Nomex® fabric swatches, passes the AATCC-22 Spray Test as follows: at least a 40 rating; preferably at least a 60 rating, and more preferably at least a 80 rating. The higher the number, the better repellency.

Submersion Test

A composition of the present invention, prepared in accordance with Example 1, after being applied as described above and cured to Nomex® fabric swatches is compared to an untreated similar article. The test was conducted as follows: pieces of 2″×2″ Nomex® fabric were cut and treated with the inventive composition of Example 1, and without treatment respectively. They were then heat dried for 2 minutes at 80° C., and allowed to soak with gasoline until saturation (by submerging them for 10 seconds) in two separate beakers. The treated fabric was weighed and percentage gain calculated.

Results are shown in Table 1:

TABLE I

| | Fabric | Fabric Plus | Grams of | Percentage of |
|---|---|---|---|---|
| | Weight | Gasoline Weight | Gasoline | Gasoline |
| | (grams) | (grams) | Absorbed | absorbed |
| Inventive | 0.7 | 1.0 | 0.3 | 42% |
| Composition- | | | | |
| treated | | | | |
| Nomex ® | | | | |
| Untreated | 0.5 | 0.9 | 0.4 | 80% |
| Nomex ® | | | | |

Preferably the treated fabric exhibits a reduction of fuel absorption of at least 20%, or at least 30% or at least 40%, more preferably a reduction of absorption of at least 50%, or at least 60%, and most preferably a reduction of absorption of at least 70%,

The submersion test measures the resistance of the material to fuel sorption under conditions similar to those that might be encountered under actual conditions, i.e. saturation with fuel following an accident.

Floating Test

Resistance to gasoline absorption was also demonstrated by again cutting 2″×2″ pieces of Nomex® fabric, one of which was treated with the inventive composition according to Example 1, and the other without treatment. They were both heat dried at 80° C. for 2 minutes. Each swatch was placed in a beaker containing gasoline, with the results that the untreated swatch immediately adsorbed liquid and sank, which the treated swatch did not sink after 10 minutes exposure.

Repellency Test AATCC 118-2002

Gasoline repellency of a composition of the present invention and two prior art compositions were tested. A composition according to Example 1, and the two prior art compositions were each applied to separate 2″×2″ swatches of fabric as shown. The amount of gasoline specified by the test standard was applied to the swatches by an eye dropper.

Grading was done according to AATCC Test Method 118-2002, published in the Technical Manual of the American Association of Textile Chemists and Colorants. P. O. Box 12215, Research Triangle Park, N.C. 27709, USA.

Grading Scale; A=Clear well-rounded drop; B=Rounding drop with partial darkening; C=Wicking apparent; D=Complete Wetting.

Results are shown in Table 2 below:

TABLE 2

| Treatment/substrate | Rating |
|---|---|
| Inventive Composition/Nomex ® | A |
| Nikwax - Waterproofing for fleece/Nomex ® | D |
| Granger's - Waterproofing for Synthetic | D |
| Fabrics/Nomex ® | |
| SCOTCHGARD ®/Nomex ® | D |

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

1. A method for increasing protective properties of a fabric, the method comprising:
imparting on a fabric a resistance to sorption of an inflammable liquid by applying to the fabric a composition comprising a fluorocompound and a carrier; and
curing the composition.

2. A method as recited in claim 1, wherein the fabric is an aromatic polyamide, a polyacrylonitrile, an oxidized polyacrylonitrile, or a mixture thereof.

3. A method as recited in claim 1, wherein the fabric is a meta-aramid [poly(phenyleneisophthalamide)].

4. A method as recited in claim 1, wherein the fabric comprises a material selected from a group consisting of leather, polyester, cotton, nylon, and wood.

5. A method as recited in claim 1, wherein the composition further includes a curing agent.

6. A method as recited in claim 1, wherein the composition further includes a crosslinking agent.

7. A method as recited in claim 6, wherein the crosslinking agent comprises a silicone-containing material.

8. A method as recited in claim 1, wherein the composition reduces a surface energy of the fabric with composition thereon to below about 25 dyne/cm.

9. A method as recited in claim 1, wherein the composition is applied to the fabric by spraying the composition onto the fabric.

10. A method as recited in claim 1, wherein the composition is applied to the fabric by immersing the fabric in the composition.

11. A method as recited in claim 1, wherein the composition is applied to the fabric by rolling the composition onto the fabric.

12. A method as recited in claim 1, wherein the composition is applied in an amount sufficient to saturate the fabric.

13. A method for reducing a risk of injury by fire, the method comprising:
wearing a protective garment treated according to the method of claim 1 under conditions which could result in exposure of the garment to a fuel.

14. A method for treating a fabric to increase the fire protective properties thereof, the method comprising:
imparting on a fabric a resistance to sorption of gasoline by applying to the fabric a composition comprising a fluorocompound; and
curing the composition by drying the fabric with composition thereon at a temperature greater than about 15° C.

15. A method as recited in claim 14, wherein the composition is applied to the fabric by at least one of spraying the composition onto the fabric, immersing the fabric in the composition, and rolling the composition onto the fabric.

16.-30. (canceled)

31. A method as recited in claim 1, wherein the fabric with cured composition thereon exhibits a reduction of fuel absorption of at least 20% relative to the fabric without the cured composition thereon.

32. A method as recited in claim 1, wherein the fabric with cured composition thereon has an A grade according to AATCC Test Method 118-2002 when contacted with gasoline according to the test procedure of AATCC Test Method 118-2002.

33. A method as recited in claim 14, wherein the fabric with cured composition thereon exhibits a reduction of fuel absorption of at least 20% relative to the fabric without the cured composition thereon.

34. A method as recited in claim 14, wherein the fabric with cured composition thereon has an A grade according to AATCC Test Method 118-2002 when contacted with gasoline according to the test procedure of AATCC Test Method 118-2002.

35. A method for increasing protective properties of a fabric, the method comprising:
imparting on a fabric a resistance to sorption of an inflammable liquid by applying to the fabric a composition comprising a fluorocompound and a carrier; and
curing the composition,
wherein the fabric with cured composition thereon exhibits a reduction of fuel absorption of at least 20% relative to the fabric without the cured composition thereon,
wherein the fabric with cured composition thereon has an A grade according to AATCC Test Method 118-2002 when contacted with gasoline according to the test procedure of AATCC Test Method 118-2002.

36. A method as recited in claim 35, wherein the fabric is an aromatic polyamide, a polyacrylonitrile, an oxidized polyacrylonitrile, or a mixture thereof.

37. A method as recited in claim 35, wherein the fabric is a meta-aramid [poly(phenyleneisophthalamide)].

38. A method as recited in claim 35, wherein the fabric comprises a material selected from a group consisting of leather, polyester, cotton, nylon, and wood.

39. A method as recited in claim 35, wherein the composition further includes a curing agent.

40. A method as recited in claim 35, wherein the composition further includes a crosslinking agent.

41. A method as recited in claim 40, wherein the crosslinking agent comprises a silicone-containing material.

42. A method as recited in claim 35, wherein the composition reduces a surface energy of the fabric with composition thereon to below about 25 dyne/cm.

43. A method as recited in claim 35, wherein the composition is applied in an amount sufficient to saturate the fabric.

44. A method as recited in claim 35, wherein the composition is applied to the fabric by at least one of spraying the composition onto the fabric, immersing the fabric in the composition, and rolling the composition onto the fabric.
